(19) United States
(12) Patent Application Publication
(10) Pub. No.: US 2025/0364851 A1
(43) Pub. Date: Nov. 27, 2025

(54) SILICONE FOAM FOR E-MOTORS

(71) Applicant: Schaeffler Technologies AG & Co. KG, Herzogenaurach (DE)

(72) Inventors: Pedro Angel Hernandez, Irapuato (MX); David Sebastian Puma Benavides, Puebla (MX)

(73) Assignee: Schaeffler Technologies AG & Co. KG, Herzogenaurach (DE)

(21) Appl. No.: 18/670,115

(22) Filed: May 21, 2024

(51) Int. Cl. H02K 1/18; H02K 3/50

(52) U.S. Cl. CPC H02K 1/18; H02K 3/50; H02K 2203/09

(57) ABSTRACT

An electric motor assembly including a stator carrier, a stator supported by the stator carrier, at least one gap defined by between respective surface of the stator and the stator carrier, and at least one foam member interposed between the respective surfaces of the stator and the stator carrier in gap to reduce vibration.

### TECHNICAL FIELD

The present disclosure relates to an electric motor assembly.

### BACKGROUND

Electric motors generally include a stator, rotor, and other components. One such component is a busbar or contact carrier, which provides an electrical interface with a stator. The busbar and stator are supported in a stator carrier. Based on the varying shapes and sizes of electric motors, busbars can take on a variety of shapes, sizes, and configurations.

### SUMMARY

In some applications, vibration either from resonant frequencies during operation of an electric motor or external vibrations transmitted to the electric motor can result in a failure of one or more of the many welded connections of a busbar. Accordingly, there is a need to support the busbar and/or stator in the stator carrier in a manner that reduces or eliminated the effects of vibration from all causes.

In accordance with one aspect of the present disclosure, an electric motor assembly comprises a stator carrier, a stator supported by the stator carrier, at least one gap defined between respective surfaces of the stator and the stator carrier, and at least one foam member interposed between the respective surfaces of the stator and the stator carrier in gap.

The gap can include at least one of an axial gap extending in an axial direction or a radial gap extending in a radial direction. The at least one foam member can be at least partially compressed between the stator and the stator carrier. The at least one foam member can include a silicone foam member. The silicone foam member can be a closed cell foam. The silicone foam member can include at least one of silicon carbide or silicon nitride. The at least one foam member can include an adhesive. The at least one foam member can include a plurality of circumferentially spaced-apart foam members. The stator can include a busbar. The busbar can include an axial end face and an outer circumferential surface, and the at least one gap can be defined between at least one of the axial end face or the outer circumferential surface and a surface of the stator carrier. The at least one foam member can cover a majority of an axial end face of a high-voltage connection portion of the busbar.

### BRIEF DESCRIPTION OF THE DRAWING(S)

The foregoing Summary and the following Detailed Description will be better understood when read in conjunction with the appended drawings, which illustrate a preferred embodiment of the disclosure. In the drawings:

FIG. 1 is a plan view of a portion of an exemplary electric motor assembly; and

FIG. 2 is an enlarged portion of FIG. 1 including foam members in accordance with the present disclosure.

### DETAILED DESCRIPTION OF THE PREFERRED EMBODIMENT(S)

Certain terminology is used in the following description for convenience only and is not limiting. The words “front,” “rear,” “upper” and “lower” designate directions in the drawings to which reference is made. The words “inwardly” and “outwardly” refer to directions toward and away from the parts referenced in the drawings. “Axially” refers to a direction along the axis of a shaft. A reference to a list of items that are cited as “at least one of a, b, or c” (where a, b, and c represent the items being listed) means any single one of the items a, b, or c, or combinations thereof. The terminology includes the words specifically noted above, derivatives thereof and words of similar import.

Embodiments of the present disclosure are described herein. It should be appreciated that like drawing numbers appearing in different drawing views identify identical, or functionally similar, structural elements. Also, it is to be understood that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

The terminology used herein is for the purpose of describing particular aspects only and is not intended to limit the scope of the present disclosure. Unless defined otherwise, all technical and scientific terms used herein have the same meaning as commonly understood to one of ordinary skill in the art to which this disclosure belongs. Although any methods, devices or materials similar or equivalent to those described herein can be used in the practice or testing of the disclosure, the following example methods, devices, and materials are now described.

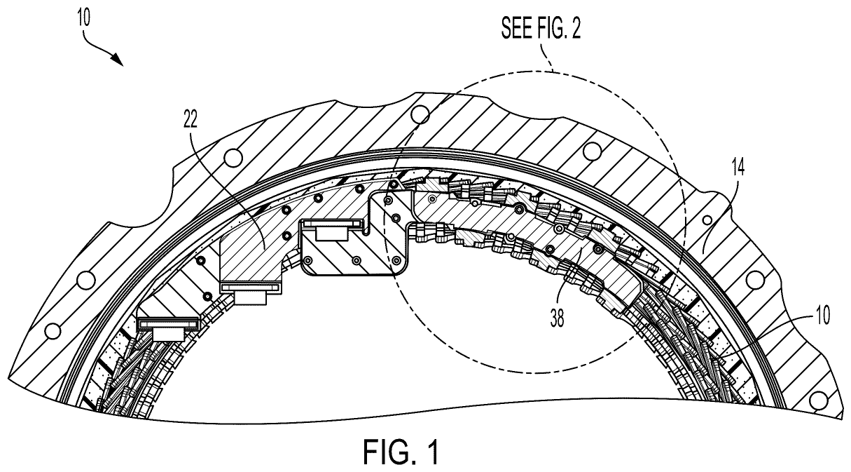

Referring to FIG. 1, a portion of an electric motor assembly is illustrated and identified generally by reference numeral 10. The electric motor assembly 10 includes a stator carrier 14 supporting a stator 18 with a busbar assembly 22. The busbar assembly 22 generally incudes a ring body 26. In one aspect, the busbar assembly 22 is formed by injection molding. More specifically, the busbar assembly 22 can be formed by overmolding.

The busbar assembly 22 includes a high-voltage connection portion 38. The busbar assembly 22 and the high-voltage connection portion 38 can be integrally formed or molded with each other, as shown in the Figures.

As used in this application, the term high-voltage can refer to 48 volts. In another aspect, the term high-voltage refers to applications using hundreds of volts. In another aspect, one skilled in the art would understand that the concepts and features disclosed herein can be used in connection with low voltage applications.

It will be appreciated that a wide range of stators and busbar assemblies can be used in connections with aspects of the present disclosure and that the illustrated stator 18 and busbar assembly 22 of FIG. 1 are exemplary in nature.

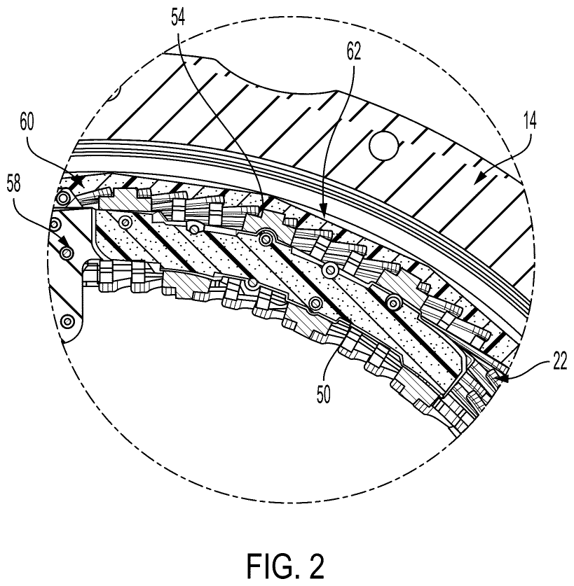

Turning to FIG. 2, and in accordance with the present disclosure, the electric motor assembly 10 is shown including foam inserts 50 and 54 for reducing vibration and enhancing heat transfer from the stator 18 and/or busbar assembly 22. Foam insert 50 is positioned on an axial end face 58 of the busbar assembly 22 and foam insert 54 is placed between a circumferential outer surface 60 of the stator 18 in an annular gap 62 between the stator 22 and the stator carrier 14. In some embodiments, the foam inserts 54 and/or 58 are at least partially compressed between adjacent components.

In one example, a silicone foam is used for the foam inserts 50 and 54. The silicone foam can be, for example, a super-resilient high-temperature silicone foam of closed-cell construction. Certain types of silicone foams, such as silicone foams with silicon carbide of silicon nitride matrices can be used. The silicone foams generally have good thermal conductivity and can increase heat transfer from the stator 18 and/or busbar assembly 22 to the stator carrier 14 and, ultimately, the ambient environment.

The foam inserts 50 and 54 can be secured in place. In one embodiment, the foam inserts 50 and 54 can be adhesive backed foam adhered to one or more of the components of the electric motor assembly 10. In other embodiments, the foam inserts 50 and 54 can be secured in place with fasteners or tape, or held in place by friction.

A plurality of foam inserts 50 and/or 54 can be circumferentially-spaced around a circumference of the stator 18 and/or busbar assembly 22. In some embodiments, the foam inserts 50 and/or 54 can be circumferentially continuous about the electric motor assembly. The foam inserts 50 and/or 54 can have a range of thicknesses depending on the particular application. As shown in FIG. 2, the foam insert 50 covers a majority of the connection portion 38.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

Having thus described the present embodiments in detail, it is to be appreciated and will be apparent to those skilled in the art that many physical changes, only a few of which are exemplified in the detailed description of the disclosure, could be made without altering the inventive concepts and principles embodied therein.

It is also to be appreciated that numerous embodiments incorporating only part of the preferred embodiment are possible which do not alter, with respect to those parts, the inventive concepts and principles embodied therein.

The present embodiment and optional configurations are therefore to be considered in all respects as exemplary and/or illustrative and not restrictive, the scope of the disclosure being indicated by the appended claims rather than by the foregoing description, and all alternate embodiments and changes to this embodiment which come within the meaning and range of equivalency of said claims are therefore to be embraced therein.

### LOG OF REFERENCE NUMERALS

10 electric motor assembly
14 stator carrier
18 stator
22 busbar
38 high-voltage connection portion
50 foam member (insert)
54 foam member (insert)
58 axial end face
60 circumferential outer surface
62 gap

What is claimed is:

1. An electric motor assembly comprising:
a stator carrier;
a stator supported by the stator carrier;
at least one gap defined by between respective surfaces of the stator and the stator carrier; and
at least one foam member interposed between the respective surfaces of the stator and the stator carrier in gap.

2. The electric motor assembly according to claim 1, wherein the gap includes at least one of an axial gap extending in an axial direction or a radial gap extending in a radial direction.

3. The electric motor assembly according to claim 1, wherein the at least one foam member is at least partially compressed between the stator and the stator carrier.

4. The electric motor assembly according to claim 1, wherein the at least one foam member includes a silicone foam member.

5. The electric motor assembly according to claim 4, wherein the silicone foam member is a closed cell foam.

6. The electric motor assembly according to claim 5, wherein the silicone foam member includes at least one of silicon carbide or silicon nitride.

7. The electric motor assembly according to claim 1, wherein the at least one foam member includes an adhesive.

8. The electric motor assembly according to claim 1, wherein the at least one foam member includes a plurality of circumferentially spaced-apart foam members.

9. The electric motor assembly according to claim 1, wherein the stator includes a busbar.

10. The electric motor assembly according to claim 9, wherein the busbar includes an axial end face and an outer circumferential surface, and wherein the at least one gap is defined between at least one of the axial end face or the outer circumferential surface and a surface of the stator carrier.

11. The electric motor assembly according to claim 10, wherein the at least one foam member covers a majority of an axial end face of a high-voltage connection portion of the busbar.

12. A stator for an electric motor comprising:
a busbar; and
at least one foam member secured to the busbar.

13. The stator according to claim 12, wherein the busbar includes an axial end face and an outer circumferential surface, and wherein the at least one foam member is secure to at least one of the axial end face or the outer circumferential surface.

14. The stator according to claim 13, wherein the at least one foam member covers a majority of an axial end face of a high-voltage connection portion of the busbar.

15. The stator according to claim 12, wherein the at least one foam member includes a silicone foam insert.

16. The stator according to claim 15, wherein the silicone foam member is a closed cell foam.

17. The stator according to claim 16, wherein the silicone foam member includes at least one of silicon carbide or silicon nitride.

18. The stator according to claim 12, wherein the at least one foam member includes an adhesive.
